(19) United States
(12) Patent Application Publication
(10) Pub. No.: US 2020/0161626 A1
(43) Pub. Date: May 21, 2020

(54) Laminar Current Collector

(71) Applicants: Robert Bosch Battery Systems LLC, Orion, MI (US); Robert Bosch GmbH, Stuttgart (DE)

(72) Inventor: Mark Kotik, Rochester Hills, MI (US)

(21) Appl. No.: 16/196,895

(22) Filed: Nov. 20, 2018

(51) Int. Cl. H01M 4/04; H01M 2/16; H01M 2/26; H01M 10/052; H01M 4/70; H01M 2/02; H01M 2/30

(52) U.S. Cl. CPC H01M 4/0404; H01M 2/1673; H01M 2/26; H01M 2/30; H01M 4/70; H01M 2/022; H01M 10/052

(57) ABSTRACT

A battery system includes a current collector configured to provide an electrical connection between electrochemical cells of a cell array. The current collector is a plate having a laminar construction and a non-uniform thickness. In particular, the plate includes a first layer having a first thickness and a first cut out, and a second layer having a second thickness that is greater than the first thickness, and a second cut out that is aligned with the first cut out. The second layer has sufficient thickness to ensure high current carrying capability of the current collector. The first and second cut outs define a connection region for connecting to a terminal of a cell, and further define a fuse that prevents conduction of excess current.

### BACKGROUND

Battery packs provide power for various technologies ranging from portable electronics to renewable power systems and environmentally friendly vehicles. For example, hybrid electric vehicles (HEV) use a battery pack and an electric motor in conjunction with a combustion engine to increase fuel efficiency. Battery packs are formed of a plurality of battery modules, where each battery module includes several electrochemical cells. The cells are arranged in stacks and are electrically connected in series or in parallel. Likewise, the battery modules within a battery pack are electrically connected in series or in parallel. In some conventional battery packs, the cell-to-cell electrical connections may be formed using mechanical methods in which the cell-to-cell electrical connections are made via a fastener such as a nut and threaded stud. Use of this type of mechanical fastener is labor-intensive and can be prone to difficulties such as those related to over- or under-tightening of the fastener. In other conventional battery packs, the cell-to-cell electrical connections may be formed by welding an electrical conductor to the respective cell terminals, which be problematic since welding introduces elevated temperatures to the cells. Such elevated temperatures can damage the cell, and for some types of cells such as Lithium-ion cells, the elevated temperature can lead to an explosion.

### SUMMARY

In some aspects, a current collector is configured to join a first cell of a cell array to a second cell of the cell array. The current collector includes a plate that includes an electrically conductive first layer and an electrically conductive second layer. The first layer has a first layer first surface, a first layer second surface that is parallel to the first layer first surface, and first cut outs that extend between the first layer first surface and the first layer second surface. The first layer has a first thickness corresponding to a distance between the first layer first surface and the first layer second surface. The second layer has a second layer first surface that is mechanically joined, and electrically connected, to the first layer second surface. The second layer includes a second layer second surface, second cut outs that extend between the second layer first surface and the second layer second surface, and a second thickness corresponding to a distance between the second layer first surface and the second layer second surface. The second thickness is greater than the first thickness and the second cut outs have a shape that is different than the shape of the first cut outs. In addition, each second cut out is aligned with a corresponding first cut out in a direction perpendicular to the first layer first surface.

In some embodiments, the first cut outs have an irregular shape that incorporates a portion of a first circle having a first radius, the second cut outs have the shape of a second circle having a second radius, and the second radius has the same dimension as the first radius.

In some embodiments, the first cut outs have an irregular shape that incorporates a portion of a first circle having a first radius, and the second cut outs have the shape of a second circle having a second radius. The first cut outs include a protrusion that is surrounded by the portion of the first circle, and the protrusion includes a terminus and a connecting portion that extends between the terminus and a surface of the portion of the first circle. In addition, a width of the terminus is greater than a width of the connecting portion, where the term width refers to a dimension that is parallel to the first layer first surface.

In some embodiments, the connecting portion has a cross-sectional area that is set so that the connecting portion serves as a fuse that changes phase when an electrical current of a predetermined amount is carried by the connecting portion.

In some embodiments, the first cut outs and the second cut outs are each provided in the plate at a location that is spaced apart from a peripheral edge of the plate.

In some embodiments, the first cut outs and the second cut outs are arranged in a one-dimensional array.

In some embodiments, the first cut outs and the second cut outs are arranged in a two-dimensional array.

In some embodiments, the second layer first surface is mechanically joined, and electrically connected, to the first layer second surface via a process selected from the group including a lamination process, a cladding process and a brazing process.

In some embodiments, the entirety of one of the second layer first surface and the first layer second surface is mechanically joined to the other of the second layer first surface and the first layer second surface.

In some embodiments, the first layer is formed of a first material, and the second layer is formed of a second material that is different from the first material.

In some aspects, a battery module includes an array of electrochemical cells and a current collector that provides an electrical connection between at least a first cell of the array of electrochemical cells and a second cell of the array of electrochemical cells. The first cell includes a first terminal, the second cell includes a second terminal, and the current collector includes a plate having an electrically conductive first layer and an electrically conductive second layer. The first layer has a first layer first surface, a first layer second surface that is parallel to the first layer first surface, first cut outs that extend between the first layer first surface and the first layer second surface, and a first thickness corresponding to a distance between the first layer first surface and the first layer second surface. In addition, the second layer has a second layer first surface that is mechanically joined, and electrically connected, to the first layer second surface, a second layer second surface, second cut outs that extend between the second layer first surface and the second layer second surface, and a second thickness corresponding to a distance between the second layer first surface and the second layer second surface. The second thickness is greater than the first thickness. The second cut outs have a shape that is different than the shape of the first cut outs. Each second cut out is aligned with a corresponding first cut out in a direction perpendicular to the first layer first surface, and each of the first terminal and the second terminal are mechanically joined, and electrically connected, to the first layer.

In some embodiments, the first cut outs have an irregular shape that incorporates a portion of a first circle having a first radius, the second cut outs have the shape of a second circle having a second radius, and the second radius has the same dimension as the first radius.

In some embodiments, the first cut outs have an irregular shape that incorporates a portion of a first circle having a first radius, and the second cut outs have the shape of a second circle having a second radius. The first cut outs include a protrusion that is surrounded by the portion of the first circle, the protrusion includes a terminus and a connecting portion that extends between the terminus and a surface of the portion of the first circle, and a width of the terminus is greater than a width of the connecting portion, where the term width refers to a dimension that is parallel to the first layer first surface.

In some embodiments, the connecting portion has a cross-sectional area that is dimensioned so that the connecting portion serves as a fuse that changes phase when an electrical current of a predetermined amount is carried by the connecting portion.

In some embodiments, the first cut outs and the second cut outs are each provided in the plate at a location that is spaced apart from a peripheral edge of the plate.

In some embodiments, the first cut outs and the second cut outs are arranged in a one-dimensional array.

In some embodiments, the first cut outs and the second cut outs are arranged in a two-dimensional array.

In some embodiments, the second layer first surface is mechanically joined, and electrically connected, to the first layer second surface via a process selected from the group including a lamination process, a cladding process and a brazing process.

In some aspects, a current collector is configured to electrically connect a first electrochemical cell to a second electrochemical cell. The current collector includes a plate, and the plate includes a connecting region having a first thickness, and a conduction region having a second thickness. In addition, the plate includes a first layer having a first surface that provides a first outer surface of the plate, and a second layer having a first surface that is mechanically joined to and electrically connected to a second surface of the first layer. The second layer has a second surface that provides a second outer surface of the plate. The connecting region consists of a first portion of the first layer, the conduction region consists of a portion of the second layer and a second portion of the first layer, and the first thickness is less than the second thickness.

In some embodiments, the first layer has first cut outs that extend between the first layer first surface and the first layer second surface, and the second layer has second cut outs that extend between the second layer first surface and the second layer second surface. In addition, the second cut outs have a shape that is different than the shape of the first cut outs, and each second cut out is aligned with a corresponding first cut out in a direction perpendicular to the first layer first surface.

In some embodiments, a distance between the first layer first surface and the first layer second surface corresponds to the first thickness, a distance between the first outer surface of the plate and the second outer surface of the plate corresponds to the second thickness, and the second thickness is greater than the first thickness.

In some aspects, a current collector is used for electrically connecting a first terminal of a first cell to a second terminal of a second cell. The current collector includes regions of sufficiently large thickness (e.g., conduction regions) to carry high current from an array of battery cells as well regions of relatively small thickness (e.g., connection regions) that facilitate forming a welded electrical connection between the connection regions and the cell terminals. Each connecting region has a thickness that is less than the thickness of the terminal, whereby a weld between the connecting region and the terminal can be achieved at a lower temperature than would be required for a connecting region having the same or greater thickness than the terminal, and the temperature used to form the weld is less than a critical temperature at which damage to the terminal or cell would occur. In addition, by providing the connecting region with a thickness that is less than that of the terminal, it is possible to join the connecting region to the terminal via a simple, good quality weld. The current collector is a stacked arrangement of plates having different thicknesses and including cut outs at locations corresponding to the cells of the cell array. The plates of the current collector are mechanically and electrically joined together to provide a device having varying thickness so as to incorporate an integral thin connection region while also allowing for relatively thick conduction regions that can accommodate high currents.

In some aspects, the connection regions are connected to the conduction regions via a fuse that is configured to open the connection between the connection region and the conduction region if the electrical current crossing the fuse is greater than a predetermined electrical current.

### BRIEF DESCRIPTION OF THE DRAWINGS

FIG. 1 is a perspective view of a battery module in which electrochemical cells are electrically connected via a current collector.

FIG. 2 is a cut-way perspective view of a cylindrical electrochemical cell.

FIG. 3 is a top plan view of the current collector of FIG. 1.

FIG. 4 is an exploded perspective view of the current collector of FIG. 1.

FIG. 5 is a perspective cross sectional view of the current collector of FIG. 1.

FIG. 6 is a top plan view of an alternative embodiment of the current collector.

FIG. 7 is a top plan view of another alternative embodiment of the current collector.

FIG. 8 is a top plan view of yet another alternative embodiment of the current collector.

### DETAILED DESCRIPTION

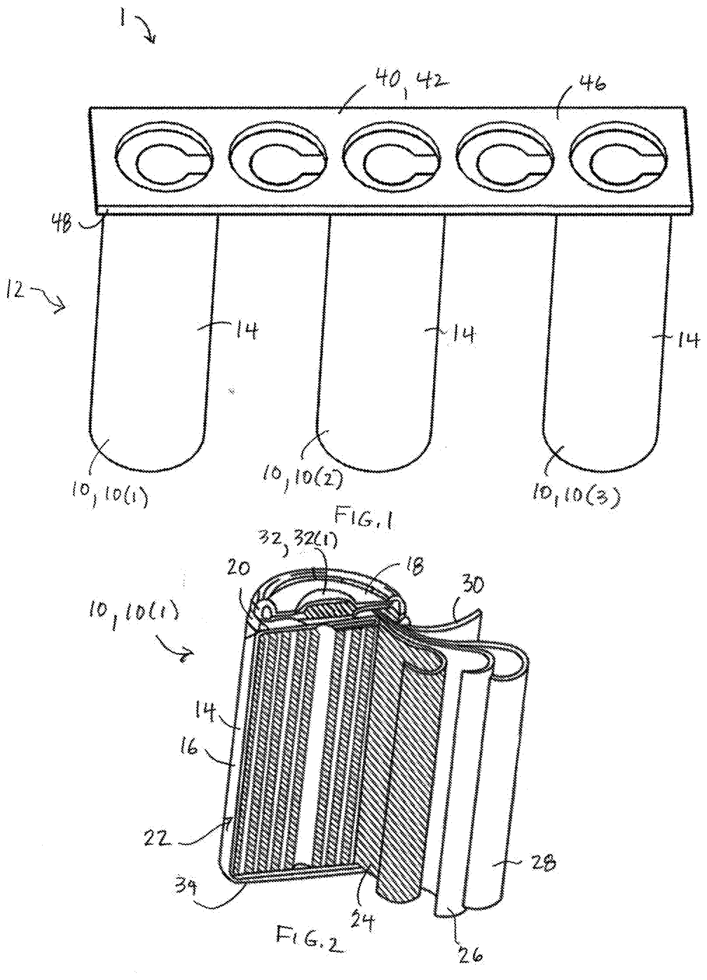

Referring to FIGS. 1 and 2, a battery module 1, used alone or in combination with other battery modules (not shown) to provide electrical power, includes electrochemical cells 10 that are electrically interconnected via a current collector 40. The cells 10 are arranged in a side-by-side configuration to form a one-dimensional cell array 12. The cells 10 are cylindrical lithium-ion cells. Each cell 10 includes a cylindrical cell housing 14 having a container portion 16 and a lid 18 that closes an open end of the container portion 16, and is sealed to the container portion 16 by an electrically insulating gasket 20. An electrode assembly 22 is sealed within the cell housing 14 along with an electrolyte to form a power generation and storage unit. The electrode assembly 22 includes a stacked arrangement of a positive electrode 24, a first separator 26, a negative electrode 28 and a second separator 30, in which the stacked arranged has been rolled to provide a “jelly roll”. One of the electrodes, for example the positive electrode 24, is electrically connected to the lid 18, which serves as a positive terminal 32 of the cell 10. In addition, the other electrode, for example the negative electrode 28, is electrically connected to the container portion 16, which serves as a negative terminal 34 of the cell 10. The current collector 40 provides an electrical connection of high current carrying capacity that joins the positive terminal 32 of a first cell 10(1) of the cell array 12 to the positive terminals (not shown) of the other cells of the cell array 12, as discussed in detail below.

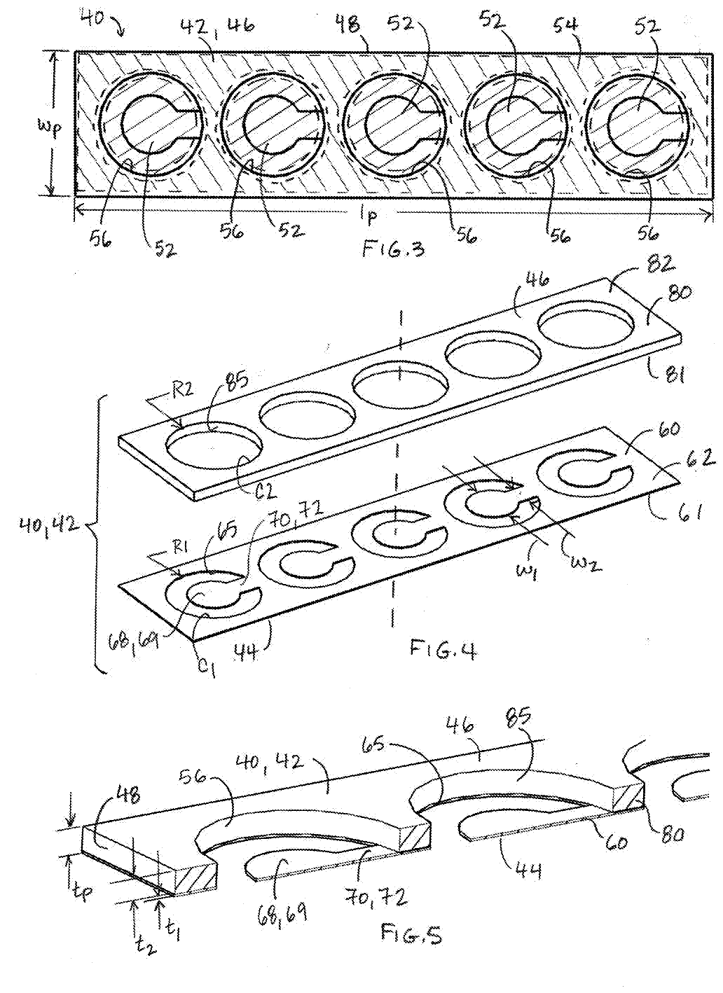

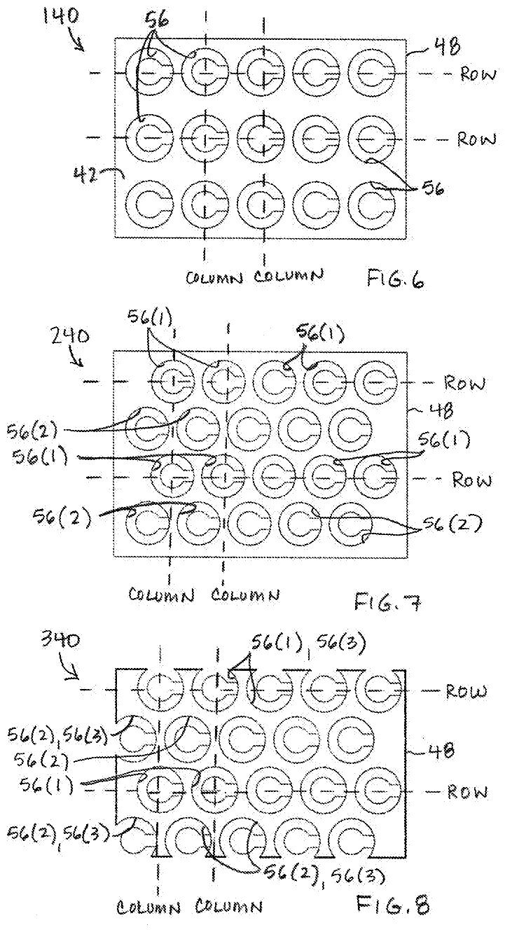

Referring to FIGS. 3-5, the current collector 40 is a plate 42 that includes a first outer surface 44 that faces the cells 10 of the cell array 12, and a second outer surface 46 that faces away from the cells 10 of the cell array 12. The first and second outer surfaces 44, 46 are spaced apart a distance corresponding the thickness tp of the plate 42. and a plate peripheral edge 48 joins the first outer surface 44 to the second outer surface 46. The plate 42 is a thin, elongated plate, where the term “thin” refers to the plate thickness tp being small relative to the width wp and length lp of the plate 42. For example, in the illustrated embodiment, the ratio of the plate thickness tp to the plate width wp is about 0.06, and the ratio of the plate thickness tp to the plate length lp is about 0.01. Although the plate 42 of the illustrated embodiment accommodates a single row of five cells 10 (e.g., is a 1 by 5 array), in an example in which the plate 42 accommodates only two cells 10 arranged in a 1 by 2 array, the ratio of the plate thickness tp to the plate length lp is about 0.03.

The plate 42 is electrically conductive and has a non-uniform thickness tp. In particular, the plate 42 includes connecting regions 52 having a first thickness t1 that are used to form an electrical connection with the terminals, for example, the positive terminals 32 of the cells 10(1), 10(2), 10(3) of the cell array 12. In addition, the plate 42 includes a conducting region 54 having a thickness that is greater than the first thickness t1. That is, the conducting region 54 has a thickness corresponding to the thickness of the plate tp. Each of the connecting regions 52 is spaced apart from the plate peripheral edge 48, and the conducting region 54 extends between the plate peripheral edge 48 and the connecting regions 52, as well as between adjacent connecting regions 52. As a result, the conducting region 54 surrounds each of the connecting regions 52.

In order to provide the plate 42 with integral connecting regions 52 that are thin relative to the conducting region 54 and to the overall plate thickness tp, the plate 42 is formed of multiple layers 60, 80 of metal foils or sheets that are individually processed to provide appropriate cut outs, are assembled into a stacked or layered arrangement and then mechanically and electrically joined along facing surfaces thereof, as will now be described in detail.

The plate 42 includes an electrically conductive first layer 60 that is used to provide the connecting regions 52, and an electrically conductive second layer 80 that, in combination with the first layer 60, is used to provide the conducting region 54.

The first layer 60 is a foil or sheet of electrically conductive material, and has a generally planar first layer first surface 61 and a first layer second surface 62 that is parallel to the first layer first surface 61. The first layer first surface 61 provides the plate first outer surface 44, and the first layer second surface 62 faces and abuts the second layer 80. The distance between the first layer first surface 61 and the first layer second surface 62, e.g. the thickness of the first layer 60, corresponds to the thickness t1 of the connecting region 52.

The first layer 60 has first cut outs 65 that extend between the first layer first surface 61 and the first layer second surface 62. The first cut outs 65 are each provided in the sheet or foil at a location that is spaced apart from a peripheral edge of the sheet or foil. In the illustrated embodiment, the first layer 60 includes five first cut outs 65 that are arranged in a single row and are equidistantly spaced apart along the row.

Each of the first cut outs 65 has the same shape. That is, each first cut out 65 has an irregular shape that incorporates a portion of a first circle C1 having a first radius R1. In addition, each first cut out 65 includes a protrusion 68 that protrudes radially inward from the first circle C1, and is surrounded by the portion of the first circle C1. The protrusion 68 includes a terminus 69 and a connecting portion 70 that extends between the terminus 69 and a surface of the first circle C1. In the illustrated embodiment, the terminus 69 has a generally circular shape when viewed in top plan view (FIG. 3). In addition, the width w1 of the terminus 69 is greater than a width w2 of the connecting portion 70, where the term “width” refers to a dimension that is parallel to the first layer first surface 61 and to the plate width wp. The connecting portion 70 has a cross-sectional area that is set so that the connecting portion 70 serves as a fuse 72 that changes phase (e.g., melts or evaporates) when an electrical current of a predetermined amount or greater is carried by the connecting portion 70. The predetermined amount of electrical current corresponds to a maximum current carrying capacity of the protrusion 68. For example, for a cylindrical lithium-ion cell size 21700, a maximum current carrying capacity may be set to be about 20 Amperes. When the fuse changes phase, which occurs when current in excess of the predetermined amount is carried by the protrusion 68, the electrical circuit between the individual cell 10 and the current collector 40 is opened.

The second layer 80 is a foil or sheet of electrically conductive material, and has a generally planar second layer first surface 81, and a second layer second surface 82 that is parallel to the second layer first surface 81. The second layer second surface 82 provides the plate second outer surface 46, and the second layer first surface 81 faces and abuts the first layer 60. More specifically, the second layer first surface 81 is mechanically joined, and electrically connected, to the first layer second surface 62. For example, the process used to join the first layer second surface 62 to the second layer first surface 81 may be selected from the group including, but not limited to, a lamination process, a cladding process and a brazing process. The second layer has a second thickness t2 that corresponds to a distance between the second layer first surface 81 and the second layer second surface 82.

The plate 42 has a plate thickness tp that the sum of the first thickness t1 and the second thickness t2. The first thickness t1 is set to be less than a thickness of the terminal 32 so that a welding process can be used to join the connecting region 52 including the protrusion 68 to the terminal 32 without incurring damage to the terminal 32. The plate thickness tp is set to be sufficient to allow the plate 42 to carry a high current from the cells of the array 12 to a battery module terminal (not shown). As used herein, the term “high current” refers to electrical current of (n times the maximum current capacity per cell), where “n” is a positive integer that refers to the number of cells that can be connected to the current collector 40, and the maximum current capacity of a cell depends on cell size and format. In the illustrated embodiment, the number n is five. In the example where the cell is a cylindrical Lithium ion cell sized 21700, the maximum current capacity is about 20 Amperes. In this example, the term “high current” refers to currents of up to (5 cells×20 Amperes per cell), or 100 Amperes. To this end, the second thickness t2 is greater than the first thickness t1. The ratio of the second thickness t2 to the first thickness t1 is at least 2. For example, in the illustrated embodiment, the second thickness t2 is 2 mm, the first thickness t1 is 0.1 mm, and the ratio of the second thickness t2 to the first thickness t1 is 20.

The second layer 80 includes second cut outs 85 that extend between the second layer first surface 81 and the second layer second surface 82. The second cut outs 85 are each provided in the sheet or foil at a location that is spaced apart from a peripheral edge of the sheet or foil. The second cut outs 85 have a shape that is different than the shape of the first cut outs 65. Specifically, the second cut outs 85 have the shape of a second circle C2 having a second radius R2, and the second radius R2 has the same dimension as the first radius R1. The second cut outs 85 are each provided in the plate 42 at a location that is spaced apart from the plate peripheral edge 48 and that is aligned with a corresponding first cut out 65 in a direction perpendicular to the first layer first surface 61. By this configuration, each first cut out 65 is aligned with a second cut out 85 to provide a through hole 56 that extends through the plate 42 and is partially obstructed by the protrusion 68.

In use, the terminus 69 of the protrusion 68 is connected to a terminal 32 of a cell 10 via a welding process. Since the second cut out 85 is a through-opening that is aligned with the first cut out 65, the terminus 69 is accessible from the second outer surface 46 of the plate 42, whereby it is possible to form the weld by inserting the welding tool into the second cut out 85. Thus, the connecting region 52, which corresponds to the protrusion 68, is mechanically and electrically connected to the cell terminal 32 via a welding process or other known method. The welding process may be, for example, a laser welding process, an ultrasonic welding process, a capacitive charge welding process or other appropriate welding process.

In the illustrated embodiment, the first layer 60 and the second layer 80 are formed of the same material. However, in other embodiments, the first layer 60 is formed of a first material, and the second layer 80 is formed of a second material that is different from the first material.

In the illustrated embodiment, the plate 42 is a laminar structure that is formed of two layers, the first layer 60 and the second layer 80. It is contemplated that, in some embodiments, the plate 42 may include more than two layers, where one layer of the multi-layer structure provides the connecting regions 52, and the remaining layers of the multi-layer structure cooperate to provide the conducting region 54.

In the embodiment illustrated in FIGS. 1-5, the through holes 56, which are defined by the first cut outs 65 and the second cut outs 85, are arranged in a one-dimensional array that can accommodate five cells 10. It is understood, however, that the current collector 40 is not limited to a one-dimensional array of through holes 56, and can be modified to provide a current collector 140 that can accommodate a two-dimensional array of cells 10 in which the through holes 56 are arranged in rows and columns (FIG. 6). In, another embodiment, the current collector 40 may be modified to provide a current collector 240 that can accommodate a two-dimensional array of cells 10 in which a first subset of the through holes 56(1) are arranged in a grid (e.g., in rows and columns), and a second subset of the through holes 56(2) are arranged in the interstitial spaces defined between the rows and columns occupied by the through holes 56(1) of the first subset (FIG. 7). The arrangement of FIG. 7 may be advantageous relative to that shown in FIG. 6 due to more efficient packing of the cells within available space.

Although the illustrated embodiment the through holes 56, including first cut outs 65 and the second cut outs 85, are arranged in a one-dimensional array that can accommodate five cells 10, only three cells 10 are electrically connected by the current collector 40. It is understood that a fewer number of cells 10 could be electrically connected by the current collector 40, or as many as five cells can be electrically connected by the current collector 40 as shown. It is further understood that the current collector 40 is not limited to a 1×5 array of cells, and can be modified to accommodate a greater or fewer number of cells by increasing or decreasing the number of cut outs.

In the illustrated embodiment, the first cut outs 65 and the second cut outs 85 are each provided in the respective sheet or foil at a location that is spaced apart from a peripheral edge thereof, whereby the through holes 56 are spaced apart from, the peripheral edge 48 of the plate 42 (FIGS. 3-7). However, in other embodiments, the outermost through holes 56(3), for example the through holes 56(3) that are adjacent to the peripheral edge of the plate 42, may be provided at a location that intersects the plate peripheral edge 48. For a given number of through holes 56 and arrangement of through holes 56, providing the outermost through holes 56(3) at a location that intersects the peripheral edge 48 reduces the overall length and width of the plate 42. and thus also reduces material costs.

In the illustrated embodiment, the current collector 40 is formed of a plate having a varying or non-uniform thickness that is achieved by joining metal foils or sheets of different thicknesses after cut outs 65, 85 have been applied. As a result, the current collector 40 has a varying thickness that corresponds to the thickness of the individual layers rather than being formed by a coining or stamping process.

In addition, the current collector 40 employs metal foils or sheets of different thicknesses that shaped and joined together to provide a current collector 40 that is relatively thick in areas of high current flow and relatively thin in areas where a lower current flows. The thin areas facilitate welding of the cell terminal to the current collector 40 without damage to the cell 10.

Although the cell 10 described in the illustrated embodiment is a lithium-ion electrochemical cell, the cells 10 that are connected using the clip are not limited to a lithium-ion electrochemical cell. For example, the cell 10 may be a nickel metal hydride, nickel cadmium cell, aluminium-ion cell or other type of cell. Moreover, although the cell 10 is described as having a cylindrical shape, the cell 10 may be formed in a different shape, such as a prismatic or a pouch shape.

Although the current collector 40 is described as having a generally rectangular profile when seen in top plan view (FIG. 3), the current collector 40 is not limited to a rectangular shape. For example, in some embodiments, the current collector 40 may be polygonal in shape, elliptical in shape, or have an irregular curvilinear shape, when seen in top plan view.

Although the terminus 69 is described as having a circular shape when seen in top plan view, the terminus 69 is not limited to a circular shape. For example, in some embodiments, the terminus 69 may be polygonal when seen in top plan view or have any other appropriate shape.

Although the positive electrode 24 is described here as being electrically connected to the lid 18, and the negative electrode 28 is described here as being electrically connected to the container portion 16, it is understood that the cell 10 may alternatively be configured so that the positive electrode 24 is electrically connected to the container portion 16, and the negative electrode 28 is electrically connected to the lid 18.

Selective illustrative embodiments of the battery module and current collector are described above in some detail. It should be understood that only structures considered necessary for clarifying the battery module and current collector have been described herein. Other conventional structures, and those of ancillary and auxiliary components of the battery module and current collector, are assumed to be known and understood by those skilled in the art. Moreover, while working examples of the battery module and current collector have been described above, the battery module and current collector are not limited to the working examples described above, but various design alterations may be carried out without departing from the devices as set forth in the claims.

What is claimed is:

1. A current collector configured to join a first cell of a cell array to a second cell of the cell array, the current collector comprising a plate that includes an electrically conductive first layer and an electrically conductive second layer, wherein
the first layer has
a first layer first surface,
a first layer second surface that is parallel to the first layer first surface,
first cut outs that extend between the first layer first surface and the first layer second surface, and
a first thickness corresponding to a distance between the first layer first surface and the first layer second surface,
the second layer has
a second layer first surface that is mechanically joined, and electrically connected, to the first layer second surface,
a second layer second surface,
second cut outs that extend between the second layer first surface and the second layer second surface, and
a second thickness corresponding to a distance between the second layer first surface and the second layer second surface,
the second thickness is greater than the first thickness,
the second cut outs have a shape that is different than the shape of the first cut outs, and
each second cut out is aligned with a corresponding first cut out in a direction perpendicular to the first layer first surface.

2. The current collector of claim 1, wherein
the first cut outs have an irregular shape that incorporates a portion of a first circle having a first radius, the second cut outs have the shape of a second circle having a second radius, and the second radius has the same dimension as the first radius.

3. The current collector of claim 1, wherein
the first cut outs have an irregular shape that incorporates a portion of a first circle having a first radius,
the second cut outs have the shape of a second circle having a second radius,
the first cut outs include a protrusion that is surrounded by the portion of the first circle,
the protrusion includes a terminus and a connecting portion that extends between the terminus and a surface of the portion of the first circle, and
a width of the terminus is greater than a width of the connecting portion, where the term width refers to a dimension that is parallel to the first layer first surface.

4. The current collector of claim 3, wherein the connecting portion has a cross-sectional area that is set so that the connecting portion serves as a fuse that changes phase when an electrical current of a predetermined amount is carried by the connecting portion.

5. The current collector of claim 1, wherein the first cut outs and the second cut outs are each provided in the plate at a location that is spaced apart from a peripheral edge of the plate.

6. The current collector of claim 1, wherein the first cut outs and the second cut outs are arranged in a one-dimensional array.

7. The current collector of claim 1, wherein the first cut outs and the second cut outs are arranged in a two-dimensional array.

8. The current collector of claim 1, wherein the second layer first surface is mechanically joined, and electrically connected, to the first layer second surface via a process selected from the group including a lamination process, a cladding process and a brazing process.

9. The current collector of claim 8, wherein the entirety of one of the second layer first surface and the first layer second surface is mechanically joined to the other of the second layer first surface and the first layer second surface.

10. The current collector of claim 1, wherein the first layer is formed of a first material, and the second layer is formed of a second material that is different from the first material.

11. A battery module comprising an array of electrochemical cells and a current collector that provides an electrical connection between a first cell of the array of electrochemical cells and a second cell of the array of electrochemical cells, wherein
the first cell comprises a first terminal,
the second cell comprises a second terminal, and
the current collector comprises a plate that includes an electrically conductive first layer and an electrically conductive second layer, wherein
the first layer has
a first layer first surface,
a first layer second surface that is parallel to the first layer first surface,
first cut outs that extend between the first layer first surface and the first layer second surface, and
a first thickness corresponding to a distance between the first layer first surface and the first layer second surface, and
the second layer has
a second layer first surface that is mechanically joined, and electrically connected, to the first layer second surface,
a second layer second surface,
second cut outs that extend between the second layer first surface and the second layer second surface, and
a second thickness corresponding to a distance between the second layer first surface and the second layer second surface,
wherein,
the second thickness is greater than the first thickness,
the second cut outs have a shape that is different than the shape of the first cut outs,
each second cut out is aligned with a corresponding first cut out in a direction perpendicular to the first layer first surface, and
each of the first terminal and the second terminal are mechanically joined, and electrically connected, to the first layer.

12. The battery module of claim 11, wherein
the first cut outs have an irregular shape that incorporates a portion of a first circle having a first radius,
the second cut outs have the shape of a second circle having a second radius, and
the second radius has the same dimension as the first radius.

13. The battery module of claim 11, wherein
the first cut outs have an irregular shape that incorporates a portion of a first circle having a first radius,
the second cut outs have the shape of a second circle having a second radius,
the first cut outs include a protrusion that is surrounded by the portion of the first circle,
the protrusion includes a terminus and a connecting portion that extends between the terminus and a surface of the portion of the first circle, and
a width of the terminus is greater than a width of the connecting portion, where the term width refers to a dimension that is parallel to the first layer first surface.

14. The battery module of claim 13, wherein the connecting portion has a cross-sectional area that is dimensioned so that the connecting portion serves as a fuse that changes phase when an electrical current of a predetermined amount is carried by the connecting portion.

15. The battery module of claim 11, wherein the first cut outs and the second cut outs are each provided in the plate at a location that is spaced apart from a peripheral edge of the plate.

16. The battery module of claim 11, wherein the first cut outs and the second cut outs are arranged in a one-dimensional array.

17. The battery module of claim 11, wherein the first cut outs and the second cut outs are arranged in a two-dimensional array.

18. The battery module of claim 11, wherein the second layer first surface is mechanically joined, and electrically connected, to the first layer second surface via a process selected from the group including a lamination process, a cladding process and a brazing process.

19. A current collector configured to electrically connect a first electrochemical cell to a second electrochemical cell, the current collector comprising a plate, the plate including:
a first layer having a first surface that provides a first outer surface of the plate;
a second layer having a first surface that is mechanically joined to and electrically connected to a second surface of the first layer, the second layer having a second surface that provides a second outer surface of the plate;
a connecting region having a first thickness, the connecting region consisting of a first portion of the first layer; and
a conduction region having a second thickness, the conduction region consisting of a portion of the second layer and a second portion of the first layer,
wherein the first thickness is less than the second thickness.

20. The current collector of claim 19, wherein
the first layer has first cut outs that extend between the first layer first surface and the first layer second surface,
the second layer has second cut outs that extend between the second layer first surface and the second layer second surface,
the second cut outs have a shape that is different than the shape of the first cut outs, and
each second cut out is aligned with a corresponding first cut out in a direction perpendicular to the first layer first surface.
